(19) United States
(12) Patent Application Publication
(10) Pub. No.: US 2025/0341402 A1
(43) Pub. Date: Nov. 6, 2025

(54) INFORMATION PROCESSING DEVICE, MOVABLE APPARATUS, INFORMATION PROCESSING DEVICE CONTROL METHOD, AND STORAGE MEDIUM

(71) Applicant: CANON KABUSHIKI KAISHA, Tokyo (JP)

(72) Inventor: Koichiro NAKAMURA, Tokyo (JP)

(21) Appl. No.: 19/272,119

(22) Filed: Jul. 17, 2025

Related U.S. Application Data
(63) Continuation of application No. PCT/JP2023/043954, filed on Dec. 8, 2023.

(30) Foreign Application Priority Data
Jan. 27, 2023 (JP) 2023-010798

(51) Int. Cl. G01C 21/00; G06T 17/05; G06V 20/52

(52) U.S. Cl. CPC G01C 21/3804; G06T 17/05; G06V 20/52; G06V 2201/07

(57) ABSTRACT

An information processing device that provides a movable apparatus with map information to provide map information that can support a layout change even when there is a layout change between an initial map creation time and an operation time, the information processing device including an image acquisition unit configured to acquire a captured image from an imaging device, a scene recognition unit configured to recognize an object from the captured image, a map element calculation unit configured to calculate a map element from the captured image, and a map information calculation unit configured to calculate the map information from recognition information of the object obtained by the scene recognition unit and the map element obtained by the map element calculation unit, in which the map information calculation unit is configured to calculate a map element confidence degree that is a degree of confidence of the map element calculated by the map element calculation unit.

### CROSS-REFERENCE TO RELATED APPLICATIONS

This application is a Continuation of International Patent Application No. PCT/JP 2023/043954, filed Dec. 8, 2023, which claims the benefit of Japanese Patent Application No. 2023-010798, filed Jan. 27, 2023, both of which are hereby incorporated by reference herein in their entirety.

### BACKGROUND

### Field of the Technology

The present disclosure relates to an information processing device that provides map information for movable apparatus, a movable apparatus, an information processing device control method, and a storage medium.

### Description of the Related Art

Recently, there has come to be technologies of autonomous mobile robots that move autonomously to work in places such as office buildings, houses, and logistics centers. Such movable apparatus calculate feature points from captured images, figure out spaces as maps of point cloud data, sets of feature points, and the like, and thereby move autonomously.

Non-Patent Literature 1 (K. Tateno, et al., CNN-SLAM: Real-time dense monocular SLAM with learned depth prediction, IEEE Computer Society Conference CVPR, 2017) discloses a method for recognition processing constructed through machine learning based on pre-given images. In that method, in order to recognize and figure out the surrounding environment from captured images, a 3D-shaped map is created, and the map serves as the basis for estimating the position and posture of the imaging device that performed the capturing. Japanese Patent Laid-Open No. 2019-125116 introduces a method for transforming captured images and creating a map.

The Non-Patent Literature 1 is based on the premise that a trained image matches the capturing environment such as the lighting conditions of the image input to the recognizer that has been trained to be able to recognize patterns and feature points. That is, if capturing environments at the initial map creation time when training is performed do not match those at the operation time of creating and recognizing a map again (which will be referred to as an “initial map creation time” and an “operation time”, respectively, below), an accurate position and posture cannot be estimated. However, since it is difficult to match capturing environments at the initial map creation time with those at the operation time in reality, highly accurate estimation is not possible.

Japanese Patent Laid-Open No. 2019-125116 discloses a method in which an image captured at the operation time is subjected to a transformation such as a geometric or brightness transformation to match the capturing environments thereof with those at the initial map creation time. However, this method is not able to support significant changes in capturing environments such as a layout change.

### SUMMARY

An information processing device according to the present disclosure is an information processing device that provides a movable apparatus that moves autonomously in a predetermined space with map information necessary for the autonomous movement of the movable apparatus, the information processing device including an image acquisition unit configured to acquire a captured image from an imaging device, a scene recognition unit configured to recognize an object from the captured image, a map element calculation unit configured to calculate a map element from the captured image, and a map information calculation unit configured to calculate the map information from recognition information of the object obtained by the scene recognition unit and the map element obtained by the map element calculation unit, in which the map information calculation unit is configured to calculate a map element confidence degree that is a degree of confidence of the map element calculated by the map element calculation unit.

### BRIEF DESCRIPTION OF THE DRAWINGS

FIG. 1 is a block diagram illustrating a hardware configuration of an information processing device.

FIG. 2 is a configuration diagram of a map information providing device according to a first embodiment.

FIG. 3 is a configuration diagram of a map information calculation unit according to the first embodiment.

FIG. 4 is a flowchart showing a map creation step according to the first embodiment.

FIG. 5 is a configuration diagram of a map information providing device according to a second embodiment.

FIG. 6 is a configuration diagram of a map information calculation unit according to the second embodiment.

FIG. 7 is a configuration diagram of a map information updating unit according to the second embodiment.

FIG. 8 is a flowchart showing a map creation step according to the second embodiment.

FIG. 9 is a flowchart showing a map updating step according to the second embodiment.

### DESCRIPTION OF THE EMBODIMENTS

### First Embodiment

Embodiments for implementing the present disclosure will be described with reference to the drawings in detail below. Note that the embodiments described below are not intended to limit the disclosure according to the claims, and not all combinations of the features described in the embodiments are essential to the solution of the disclosure.

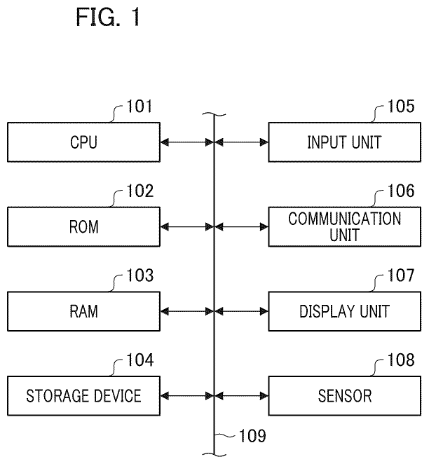

A hardware configuration of an information processing device according to the present embodiment will be described with reference to FIG. 1. FIG. 1 is a block diagram illustrating an example of the hardware configuration of the information processing device. The information processing device provides a movable apparatus that autonomously moves in a predetermined space with map information necessary for autonomous movement of the movable apparatus.

The movable apparatus moves following instructions of the information processing device based on the map information provided by the information processing device. The information processing device may be mounted in the movable apparatus or remotely control the movable apparatus.

A CPU 101 reads and executes the OS and other programs stored in a ROM 102 and a storage device 104, using a RAM 103 as a work memory. The CPU 101 controls each constituent element connected to a system bus 109 to perform arithmetic operation, logical determination, and the like for various kinds of processing.

The processing executed by the CPU 101 includes image recognition processing according to an embodiment. CPU is an abbreviation for central processing unit. RAM is an abbreviation for random access memory. ROM is an abbreviation for read only memory.

The storage device 104 is a hard disk drive, an external storage device, or the like, and stores programs and various types of data required for the image recognition processing of the embodiment. The storage device 104 is connected to the system bus 109 via an interface, for example, SATA.

Note that the CPU can function as various means by executing programs. Note that a control circuit such as ASIC that operates in cooperation with the CPU may function as such a means. In addition, such a means may be realized by cooperation of the CPU and a control circuit that controls operations of an image processing device.

In addition, the number of CPUs does not need to be one, and can be multiple. In that case, multiple CPUs can be distributed to perform processing. In addition, multiple CPUs may be arranged within a single computer, or distributed across multiple physically separate computers. Note that a function realized by the CPU performing a program may be realized by a dedicated circuit.

An input unit 105 is an imaging device such as a camera, or an input device such as buttons, a keyboard, or a touch panel for receiving input of user instructions. The input unit 105 is connected to the system bus 109 via a serial bus, for example, a USB.

A communication unit 106 communicates with an external apparatus in radio communication. A display unit 107 is a display. A sensor 108 is an image sensor or a distance sensor. Each of the input unit 105, the communication unit 106, the display unit 107, and the sensor 108 is connected to the system bus 109.

[Configuration of Map Information Providing Device] A map information providing device according to the present embodiment uses scene recognition at the time of initial map creation to recognize an object that would influence a layout change, and calculates a degree of influence of the recognized object on the layout change. Then, the map information providing device calculates a degree of confidence of a map element in a 3-dimensional space constituting a 3D-shaped map based on the degree of confidence. The map information providing device according to the present embodiment is an example of an information processing device.

A degree of confidence indicates the degree of susceptibility of a position of a map element to a change due to a layout change in the imaging environment. That is, a degree of confidence decreases as an object from which a map element is calculated becomes more susceptible to the influence of a layout change. When the estimation is performed using a degree of confidence as a weight of each map element in the weighted least squares method to estimate a position/posture, a position/posture can be estimated with high accuracy even if the imaging environment is changed due to a layout change.

In the present embodiment, a map element in a 3-dimensional space constituting a 3D-shaped map is assumed to be a feature point represented in the 3-dimensional space. Map information of the present embodiment includes a map element in the 3-dimensional space constituting the 3D-shaped map. The feature point will be referred to as a “3D feature point” hereinbelow.

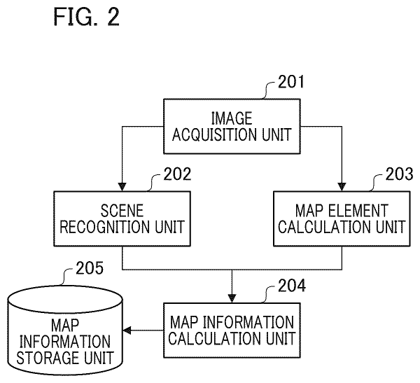

A configuration of the map information providing device according to the present embodiment will be described with reference to FIG. 2. FIG. 2 is a configuration diagram of the map information providing device according to a first embodiment.

An image acquisition unit 201 acquires a captured image captured by the imaging device. A scene recognition unit 202 performs scene recognition for the captured image acquired by the image acquisition unit 201 to recognize whether there is an object that influences a layout change in the captured image.

A desk, a chair, a box, or the like is conceivable as the “object”. As a specific method for scene recognition, for example, semantic segmentation that is one of segmentation methods may be used. The object is not limited thereto.

A map element calculation unit 203 calculates a feature point in the 2-dimensional space from the 2-dimensional image acquired by the image acquisition unit 201. Note that the “feature point” in the present embodiment is an example of the map element. A feature point represented in two dimensions within an image will be referred to as a “2D feature point” herein below.

For a method for calculating a 2D feature point, the method disclosed in Non Patent Literature 1 may be used. A map information calculation unit 204 calculates map information from the recognition information of the object obtained by the scene recognition unit 202 and the feature point obtained by the map element calculation unit 203 (details thereof will be described below). A map information storage unit 205 stores the map information calculated by the map information calculation unit 204.

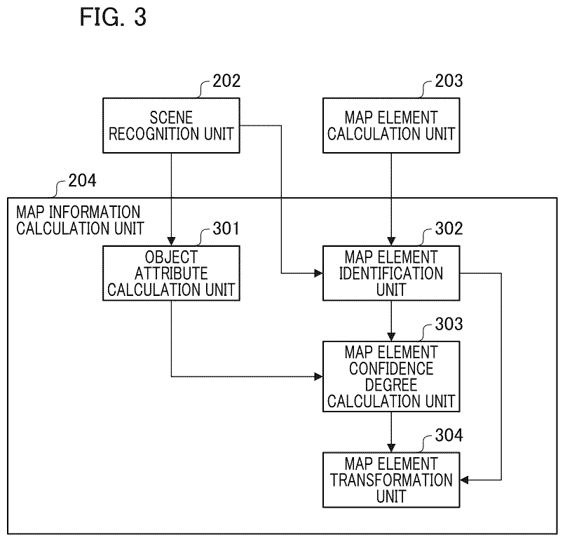

The map information calculation unit 204 will be described with reference to FIG. 3. FIG. 3 is a configuration diagram of the map information calculation unit according to the first embodiment.

An object attribute calculation unit 301 calculates attribute information of an object x recognized by the scene recognition unit 202. “X” represents an ID for identifying the recognized object. The ID is an example of map element accessory information for specifying the object and is also included in map information which will be described below.

The attribute information represents a degree of influence indicating how much the recognized object is likely to influence a layout change. The attribute information according to the present embodiment is an example of the layout change influence degree indicating how easily the object influences a layout change.

In addition, the object attribute calculation unit 301 according to the present embodiment is an example of a layout change influence degree calculation unit configured to calculate a layout change influence degree based on how easily the object influences a layout change.

In the present embodiment, two factors “a degree of ease of movement wx1” and “a degree of ease of carrying wx2” are defined as attribute information. In the calculation method, wx1=1.0 is set if wheels such as casters are attached to the object x, and wx1=0.0 is set if nothing is attached thereto. In addition, wx2=0.0 is set if the size of the object x exceeds a predetermined level, and wx2=1.0 is set if the size thereof does not exceed that level. Attribute information and a calculation method for attribute information are not limited thereto.

In addition, for attribute information, physical information obtained from features of a target object such as installation, disposition, weight, and shape thereof obtained in advance or a database constructed from a catalog may be used. In addition, a degree of ease of movement or the like may be determined based on how a model mimicking a shape behaves when an external force is applied a physical simulation.

Objects have the same attributes as long as they have similar characteristics and shapes. For this reason, the traits may be treated as attributes obtained in the scene recognition and categorized. When the scene recognition unit 202 recognizes a wall, a cardboard box, and a trolley, the degrees of ease of movement are calculated, such as wA1=0.0 for the wall, wB1=0.4 for the cardboard box, and wC1=1.0 for trolley.

A map element identification unit 302 identifies the 2D feature points obtained by the map element calculation unit 203 as a “variable feature point” and an “invariable feature point”. The map element identification unit 302 according to the present embodiment is an example of a map element identification unit configured to identify map element identification information for identifying whether a map element is a variable map element or an invariable map element.

The variable feature point is a feature point that is calculated for an object recognized by the scene recognition unit 202 and whose position is likely to change between the initial map creation time and the operation time. The variable feature point registers the ID of the object calculated from itself. The invariable feature point is a feature point that is calculated for an element other than the object recognized by the scene recognition unit 202.

When the scene recognition unit 202 uses semantic segmentation as a method for scene recognition, a feature point present in a variable area (including the boundary area) divided by segmentation is regarded a variable feature point. Conversely, a feature point not in that area is regarded as an invariable feature point.

A map element confidence degree calculation unit 303 calculates the degrees of confidence of the feature points obtained by the map element calculation unit 203. When the position and posture are estimated, the degrees of confidence may be set as the weight of each 3D feature point and then estimation may be performed using the weighted least squares method. A degree of confidence of a feature point in the present embodiment is an example of a degree of confidence of a map element.

A method for calculating a degree of confidence of the present embodiment will be described. The maximum value of the degree of confidence is set to 1.0 and the minimum value thereof is set to 0.0. The maximum value of a degree of confidence Kc of an invariable feature point is set to 1.0 uniformly. As described above, when a map element is an invariable map element in the present embodiment, the degree of confidence of the map element is calculated to the maximum possible value.

The degree of confidence of a variable feature point is calculated as Kx by using Formula (1) based on the calculated attribute information of each object x. As described above, when a map element is an invariable map element in the present embodiment, the degree of confidence is calculated using the layout change influence degree of the object whose map element has been calculated. However, a calculation method for the degree of confidence is not limited thereto.

$$Kx = 0.3 \times ( 1. - wx 1 ) + 0.3 \times ( 1. - wx 2 ) + 0.3 \qquad Formula ( 1 )$$

A map element transformation unit 304 transforms the 2D feature points obtained by the map element calculation unit 203 into 3D feature points. As described above, the map element transformation unit 304 of the present embodiment is configured to transform a map element into a map element in a 3-dimensional space constituting a 3D-shaped map.

For a method for transforming a feature point, the method disclosed in The Non Patent Literature 1 may be used. In that case, the identification information and the degree of confidence of the 2D feature point given before the transformation are maintained even after the transformation. Specifically, the position and the angle of view of the capturing direction of the imaging device are obtained, and the position and the angle of view are used to map the 2D feature points on the image that is the camera coordinate system to the 3D feature points on the 3D map that is the global coordinate system.

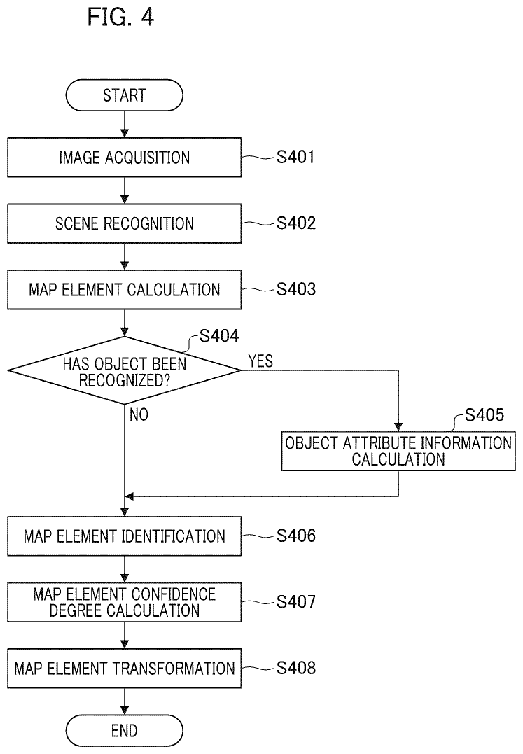

Although the degree of confidence of the feature points on the 3D map in the initial state is 1.0, feature points with the degree of confidence given on the 3D map are added or the degrees of confidence of the existing feature points are updated through the above processing.

[Map Creation Step] A map creation step according to the present embodiment will be described with reference to the flowchart of FIG. 4. FIG. 4 is a flowchart showing the map creation step according to the first embodiment. In the map creation step, the degree of confidence of a 3D feature point is calculated based on the degree of influence of the object that influences the layout change and provided as map information.

Note that, although the one CPU 101 uses one memory (the RAM 103 or the storage device 104) to execute each processing operation shown in the flowchart described below in the present embodiment, the disclosure is not limited thereto. For example, multiple CPUs or multiple RAMs or HDDs may be caused by cooperating to execute each processing operation. The following flowchart will be described by affixing S to the beginning of each step operation.

An image is acquired in S401. In S402, a scene recognition is performed for the image acquired in S401 to recognize whether there is an object that influences a layout change in the captured image. In S403, the 2D feature points are calculated from the image acquired in S402.

In S404, it is determined whether the object that influences a layout change has been recognized in the captured image of S402. If the object has been recognized, the process proceeds to S405, and if not, the process proceeds to S406. In S405, the attribute information indicating the degree of influence of the object on the layout change is calculated.

In S406, the 2D feature points calculated in S403 are identified as a “variable feature point” and an “invariable feature point”. In S407, the degrees of confidence of the 2D feature points calculated in S403 are calculated. In S408, the map element transformation unit 304 transforms the 2D feature points into 3D feature points.

In the present embodiment, the object that influences the layout change is recognized, and the degrees of confidence of the 3D feature points constituting the 3D-shaped map are calculated from the attribute information indicating the degree of influence of the object on the layout change. To estimate the position/posture, by determining whether each of the 3D feature points is used for estimation based on the degrees of confidence, the position/posture can be estimated with high accuracy even if the imaging environment is changed due to the layout change.

[Modified Example of First Embodiment] Although the map elements constituting the 3D-shaped map are assumed to be a 3D feature point group in the first embodiment, the disclosure is not limited thereto. As a map element, not only the 3D feature point group but also a line segment, a polygonal plane, or a trimmed curbed surface may be used.

The degree of confidence is calculated by associating an object that influences the layout change with the map element also for such map elements. Note that examples of a method for associating an object with a map element include a known method in which a semantic-segmented object is mapped in units of polygons.

In that case, the degree of confidence may be given to each semantic-segmented area and mapped to a polygon. Then, by estimating the position/posture using the weighted least squares method using the degree of confidence as the weight of each of map elements, the same effects as those when the map elements are 3D feature points are obtained.

[Second Embodiment] A second embodiment of the present disclosure will be described below. The same configuration as that of the above-described embodiment will be given the same reference numerals to avoid overlapping description.

[Configuration of Map Information Providing Device] The map information providing device according to the present embodiment recognizes an object that influences a layout change and detects whether a layout change has occurred due to a change in disposition of the recognized object. In addition, when a layout change occurs, the map element calculated based on the recognized object among map elements constituting the 3D-shaped map is updated. Thereby, it is possible to provide map information for the position and posture estimation corresponding to the layout change even when the layout change between the initial map creation time and the operation time has occurred.

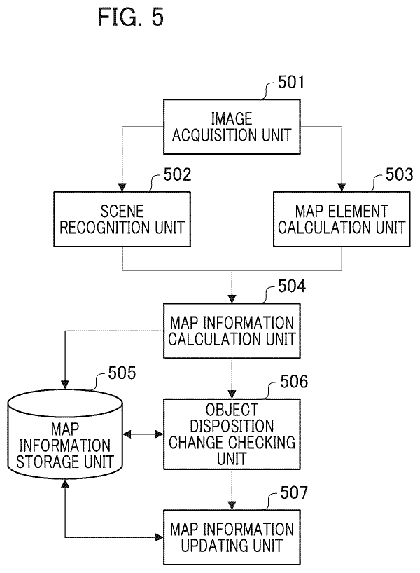

A configuration of the map information providing device according to the present embodiment will be described with reference to FIG. 5. FIG. 5 is a configuration diagram of the map information providing device according to a second embodiment.

The image acquisition unit 501 acquires a captured image captured by the imaging device. The scene recognition unit 502 performs scene recognition for the captured image acquired by the image acquisition unit 501 to recognize whether there is an object that influences a layout change in the captured image.

A desk, a chair, a box, or the like is conceivable as the “object”. As a specific method for scene recognition, for example, semantic segmentation that is one of segmentation methods may be used. The object is not limited thereto.

The map element calculation unit 503 calculates a feature point in the 2-dimensional space from the 2-dimensional image acquired by the image acquisition unit 501. A feature point represented in two dimensions within an image will be referred to as a “2D feature point” herein below. For a method for calculating a 2D feature point, the method disclosed in the Non-Patent Literature 1 may be used.

The map information calculation unit 504 calculates map information from the recognition information of the object obtained by the scene recognition unit 502 and the 2D feature point obtained by the map element calculation unit 503 (details thereof will be described below). The map information storage unit 505 stores the map information calculated by the map information calculation unit 504.

An object disposition change checking unit 506 compares the map information calculated by the map information calculation unit 504 with the map information stored in the map information storage unit 505 to check whether there is a change in the disposition of the object. A map information updating unit 507 compares the map information stored in the map information storage unit 505 if the object disposition change checking unit 506 has checked a disposition change and updates the map information (details thereof will be described below).

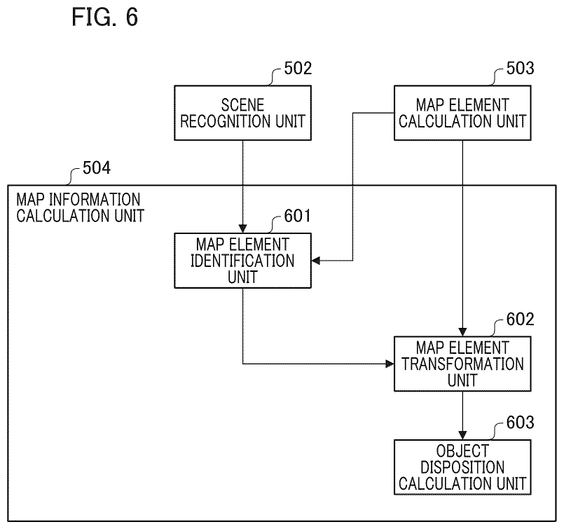

The map information calculation unit 504 will be described with reference to FIG. 6. FIG. 6 is a configuration diagram of the map information calculation unit according to the second embodiment.

A map element identification unit 601 identifies the 2D feature points obtained by the map element calculation unit 503 as a “variable feature point” and an “invariable feature point”. The variable feature point registers the ID of the object calculated from itself. The variable feature point is a feature point that is obtained from the object recognized by the scene recognition unit 502.

The variable feature point registers the ID of the object to which its own feature point belongs and the variable feature point is updated when the disposition of the object having the registered ID is changed. The invariable feature point is a feature point that is obtained from an object other than the object recognized by the scene recognition unit 502. The invariable feature point is never updated.

A map element transformation unit 602 transforms the 2D feature points obtained by the map element calculation unit 503 into 3D feature points. For a method for transforming a feature point, the method disclosed in the Non-Patent Literature 1 may be used.

At this time, the identification information of the 2D feature points given before the transformation and the information of the ID of the object to which the feature points belong are retained even after the transformation. Specifically, the position and the angle of view of the capturing direction of the imaging device are obtained, and the position and the angle of view are used to map the 2D feature points on the image that is the camera coordinate system to the 3D feature points on the 3D map that is the global coordinate system.

An object disposition calculation unit 603 calculates the three-dimensional coordinates and direction of the object recognized by the scene recognition unit 502 based on the 3D feature points obtained by the map element transformation unit 602. The map information according to the present embodiment includes object disposition information that is coordinates of the object on a three-dimensional space. In addition, the object disposition calculation unit 603 of the present embodiment is configured to calculate object disposition information based on recognition information of the object and a map element.

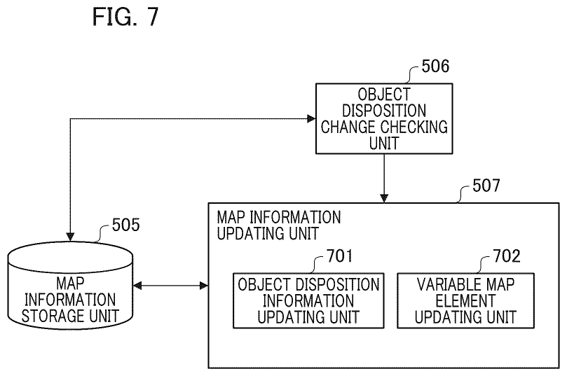

The map information updating unit 507 will be described in detail with reference to FIG. 7. FIG. 7 is a configuration diagram of the map information updating unit according to the second embodiment.

An object disposition information updating unit 701 updates the three-dimensional coordinates and direction of the object whose change in disposition has been checked. The object disposition information updating unit 701 of the present embodiment is configured to update the object disposition information when a change in the disposition of the object has been checked.

A variable map element updating unit 702 updates 3D feature points that are variable feature points belonging to the object whose change in disposition has been checked. The variable map element updating unit 702 of the present embodiment is configured to update the variable map element when a change in the disposition of the object has been checked.

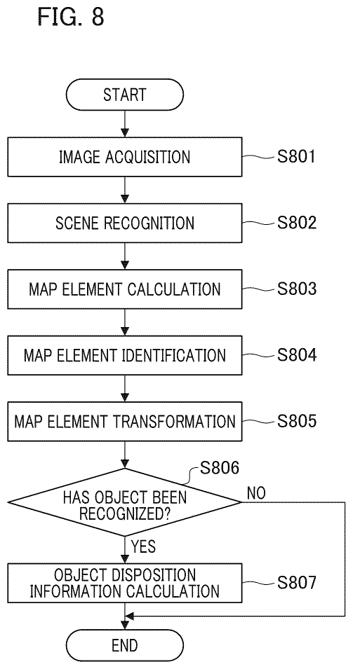

A map creation step at the initial map creation time according to the present embodiment will be described with reference to the flowchart of FIG. 8. FIG. 8 is a flowchart showing the map creation step according to the second embodiment.

In the map creation step, an object that influences a layout change is recognized and registered, and a 3D feature point that is likely to be updated from the recognition information at the operation time is registered as a variable feature point.

Thus, it is possible to check whether a layout change between the initial map creation time and the operation time has occurred and to update the 3D feature point when a layout change has occurred. In the present embodiment, it is assumed that one CPU 101 uses one memory (RAM 103 or storage device 104) to execute each processing operation shown in the flowchart described below. However, the embodiment is not limited to this configuration as described above.

An image is acquired in S801. In S802, a scene recognition is performed for the image acquired in S801 to recognize whether there is an object that influences a layout change in the captured image. In S803, the 2D feature points are calculated from the image acquired in S801.

In S804, the 2D feature points calculated in S803 are identified as a “variable feature point” and an “invariable feature point”. In S805, the map element transformation unit 602 transforms the 2D feature points into 3D feature points.

In S806, it is determined whether the object that influences a layout change has been recognized in the captured image in S802. If the object has been recognized, the process proceeds to S807. If not, the processing step ends. In S807, the 3-dimensional coordinates and direction of the object recognized in S802 are calculated.

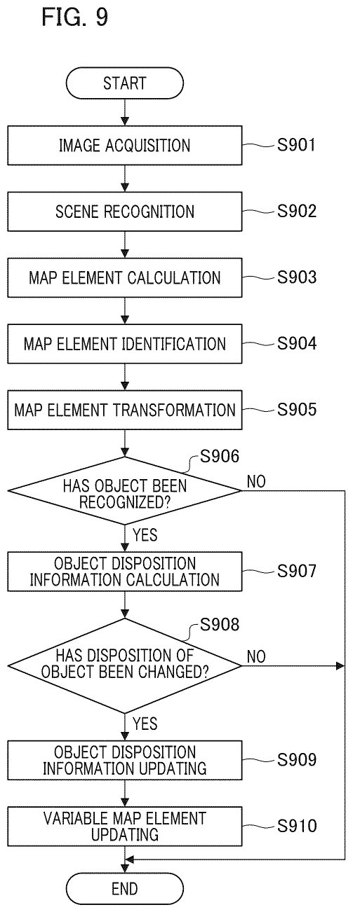

A map updating step performed at the operation time according to the present embodiment will be described with reference to the flowchart of FIG. 9. FIG. 9 is a flowchart showing the map updating step according to the second embodiment.

In the map updating step, whether a layout change between the initial map creation time and the operation time has occurred is checked, and the 3D feature points that are variable feature points are updated if a layout change occurred. This configuration can provide map information for highly accurate position and posture estimation even when the capturing environment has altered due to the layout change between the initial map creation time and the operation time.

S901 is the same as S801. S902 is the same as S802. S903 is the same as S803. S904 is the same as S804. S905 is the same as S805.

In S906, it is determined whether the object that influences a layout change has been recognized in the image in S902. If the object has been recognized, the process proceeds to S907. If not, the processing step ends. S907 is the same as S807.

In S908, it is determined whether the disposition of the object recognized in S902 has been changed. If the disposition of the object has been changed, the process proceeds to S909. If not, the processing step ends.

In S909, the disposition information of the object whose disposition change of S908 has been recognized is updated. In S910, the 3D feature points that are variable feature points belonging to the object whose disposition change of S908 has been recognized are updated.

In the present embodiment, the object that influences a layout change is recognized, and the 3D feature points are dynamically updated according to the disposition change of the object. Thus, map information for the highly accurate position and posture estimation can be provided even when the imaging environment has altered due to the layout change between the initial map creation time and the operation time.

[Modified Example of Second Embodiment] Although the map elements constituting the 3D-shaped map are assumed to be a 3D feature point group in the second embodiment, the disclosure is not limited thereto. As a map element, not only the 3D feature point group but also a line segment, a polygonal plane, or a trimmed curbed surface may be used.

For such map elements as well, the map elements are registered in association with the object that influences the layout change and the map elements, and the position and direction of the map elements are updated according to the disposition change of the object. Accordingly, the same effects as those when the map elements are 3D feature points are obtained.

Note that examples of a method for associating an object with a map element include a known method of mapping to a semantic-segmented object in units of polygons. In that case, when a degree of confidence is assigned to a feature point, the degree of confidence may be assigned to each semantic-segmented area and mapped to a corresponding polygon.

Note that, although the second embodiment has described degree of confidence, a degree of confidence may be given to 3D feature points. In this case, the map information updating unit 507 may include a map element confidence degree updating unit configured to update a degree of confidence of map information updated by the variable map element updating unit 702.

Although the present disclosure has been described based on exemplary embodiments, the present disclosure is not limited to a specific embodiment and includes various embodiments that fall within the scope not that does not depart from the gist of the present disclosure. In addition, some of the above-described multiple embodiments may be combined with each other appropriately.

The present disclosure can be realized in a process in which a program realizing one or more functions of the above-described embodiments is supplied to a system or a device via a network or a storage medium and one or more processors included in a computer of the system or the device read and execute the program. In addition, the program can be realized by a circuit (e.g., ASIC) that realizes the one or more functions.

In addition, the present disclosure includes a configuration that realizes the functions of the above-described embodiments by using, for example, at least one processor or circuit. Note that, in that case, multiple processors may be used for distributed processing.

What is claimed is:

1. An information processing device that provides a movable apparatus that moves autonomously in a predetermined space with map information necessary for the autonomous movement of the movable apparatus, the information processing device comprising:
at least one processor or circuit configured to function as:
an image acquisition unit configured to acquire a captured image from an imaging device;
a scene recognition unit configured to recognize an object from the captured image;
a map element calculation unit configured to calculate a map element from the captured image; and
a map information calculation unit configured to calculate the map information from recognition information of the object obtained by the scene recognition unit and the map element obtained by the map element calculation unit,
wherein the map information calculation unit is configured to calculate a map element confidence degree that is a degree of confidence of the map element calculated by the map element calculation unit.

2. An information processing device that provides a movable apparatus that moves autonomously in a predetermined space with map information necessary for the autonomous movement of the movable apparatus, the information processing device comprising:
at least one processor or circuit configured to function as:
an image acquisition unit configured to acquire a captured image from an imaging device;
a scene recognition unit configured to recognize an object from the captured image;
a map element calculation unit configured to calculate a map element from the captured image;
a map information calculation unit configured to calculate the map information from recognition information of the object obtained by the scene recognition unit and the map element obtained by the map element calculation unit;
a map information storage unit configured to store the map information;
an object disposition change checking unit configured to compare the map information calculated by the map information calculation unit with the map information stored in the map information storage unit and checks whether there is a change in disposition of the object recognized by the scene recognition unit; and
a map information updating unit configured to update the map information when the change in disposition has been checked by the object disposition change checking unit.

3. The information processing device according to claim 1, wherein the scene recognition unit is configured to recognize an object that influences a layout change in the predetermined space.

4. The information processing device according to claim 1, wherein the map information includes a layout change influence degree indicating how easily the object recognized by the scene recognition unit influences a layout change.

5. The information processing device according to claim 2, wherein the map information includes object disposition information including coordinates of the object recognized by the scene recognition unit in a 3-dimensional space.

6. The information processing device according to claim 1,
wherein the map information includes map information identification information indicating whether the map element calculated by the map element calculation unit is a variable map element or an invariable map element,
the variable map element is a map element calculated from the object recognized by the scene recognition unit, and
the invariable map element is a map element calculated from an object other than the object recognized by the scene recognition unit.

7. The information processing device according to claim 1, wherein the map information includes a map element in a 3-dimensional space constituting a 3-dimensional-shaped map.

8. The information processing device according to claim 6, wherein the map information includes map element accessory information for specifying the object calculated by the variable map element.

9. The information processing device according to claim 1, wherein, when a map element is a variable map element, the map element confidence degree is calculated using the layout change influence degree of the object whose map element has been calculated.

10. The information processing device according to claim 1, wherein, when a map element is an invariable map element, the map element confidence degree is calculated to a maximum possible value for the map element confidence degree.

11. The information processing device according to claim 4, wherein the map information calculation unit includes a layout change influence degree calculation unit configured to calculate the layout change influence degree based on how easily the object recognized by the scene recognition unit is configured to influence a layout change.

12. The information processing device according to claim 5, wherein the map information calculation unit includes an object disposition calculation unit configured to calculate the object disposition information from the recognition information of the object obtained by the scene recognition unit and the map element obtained by the map element calculation unit.

13. The information processing device according to claim 1, wherein the map information calculation unit includes a map element identification unit configured to identify whether the map element calculated by the map element calculation unit is a variable map element or an invariable map element.

14. The information processing device according to claim 1, wherein the map information calculation unit includes a map element transformation unit configured to transform the map element calculated by the map element calculation unit into a map element constituting a three-dimensional-shaped map in a three-dimensional space.

15. The information processing device according to claim 5, wherein the map information updating unit includes an object disposition updating unit configured to update the object disposition information when the object disposition change checking unit has checked a change in disposition of the object.

16. The information processing device according to claim 2, wherein the map information updating unit includes a variable map element updating unit configured to updates a variable map element when the object disposition change checking unit has checked a change in disposition of the object.

17. The information processing device according to claim 16, wherein the map information updating unit includes a map element confidence degree updating unit configured to updates a degree of confidence of a map element updated by the variable map element updating unit.

18. The information processing device according to claim 1, further comprising a map information storage unit configured to store the map information.

19. A movable apparatus that moves following an instruction of the information processing device according to claim 1.

20. A control method for an information processing device that provides a movable apparatus that moves autonomously in a predetermined space with map information necessary for the autonomous movement of the movable apparatus, the control method comprising:
acquiring a captured image from an imaging device;
recognizing an object from the captured image;
calculating a map element from the captured image;
calculating the map information from recognition information of the object and the map element; and
calculating a map element confidence degree that is a degree of confidence of the map element.

21. A control method for an information processing device that provides a movable apparatus that moves autonomously in a predetermined space with map information necessary for the autonomous movement of the movable apparatus, the control method comprising:
acquiring a captured image from an imaging device;
recognizing an object from the captured image;
calculating a map element from the captured image;
calculating the map information from recognition information of the object and the map element;
storing the map information;
comparing the map information with the map information and checking whether there is a change in disposition of the object; and
updating the map information when the change in disposition has been checked.

22. A non-transitory computer-readable storage medium configured to store a computer program to control an information processing device that provides a movable apparatus that moves autonomously in a predetermined space with map information necessary for the autonomous movement of the movable apparatus, the computer program includes instructions for executing following processes:
acquiring a captured image from an imaging device;
recognizing an object from the captured image;
calculating a map element from the captured image;
calculating the map information from recognition information of the object and the map element; and
calculating a map element confidence degree that is a degree of confidence of the map element.

23. A non-transitory computer-readable storage medium configured to store a computer program to control an information processing device that provides a movable apparatus that moves autonomously in a predetermined space with map information necessary for the autonomous movement of the movable apparatus, the computer program includes instructions for executing following processes:
acquiring a captured image from an imaging device;
recognizing an object from the captured image;
calculating a map element from the captured image;
calculating the map information from recognition information of the object and the map element;
storing the map information;
comparing the map information with the map information and checking whether there is a change in disposition of the object; and
updating the map information when the change in disposition has been checked.
